(19) United States
(12) Patent Application Publication
(10) Pub. No.: US 2016/0297369 A1
(43) Pub. Date: Oct. 13, 2016

(54) UMBRELLA MOUNTING SYSTEM

(71) Applicant: Heinz Strakelijahn, Kent, WA (US)

(72) Inventor: Heinz Strakelijahn, Kent, WA (US)

(21) Appl. No.: 14/683,780

(22) Filed: Apr. 10, 2015

(51) Int. Cl. B60R 7/12

(52) U.S. Cl. CPC B60R 7/12

(57) ABSTRACT

An umbrella mounting system a vehicle including an interior surface. A clip is attached to the interior surface and includes a mount section attached to the interior surface and a saddle attached to the mount section. A securing member attaches the clip to the interior surface and an umbrella is removably positioned in the clip.

### BACKGROUND OF THE DISCLOSURE

### Field of the Disclosure

The disclosure relates to umbrella holding devices and more particularly pertains to a new umbrella holding device for mounting an umbrella in a vehicle such that the umbrella properly dries after being used.

### SUMMARY OF THE DISCLOSURE

An embodiment of the disclosure meets the needs presented above by generally comprising a vehicle including an interior surface. A clip is attached to the interior surface and includes a mount section attached to the interior surface and a saddle attached to the mount section. A securing member attaches the clip to the interior surface and an umbrella is removably positioned in the clip.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of an umbrella mounting system according to an embodiment of the disclosure.

FIG. 2 is a rear, bottom perspective view of an embodiment of the disclosure.

FIG. 3 is a cross-sectional view of an embodiment of the disclosure taken along line 3-3 of FIG. 1.

FIG. 4 is a front in-use view of an embodiment of the disclosure.

### DESCRIPTION OF THE PREFERRED EMBODIMENT

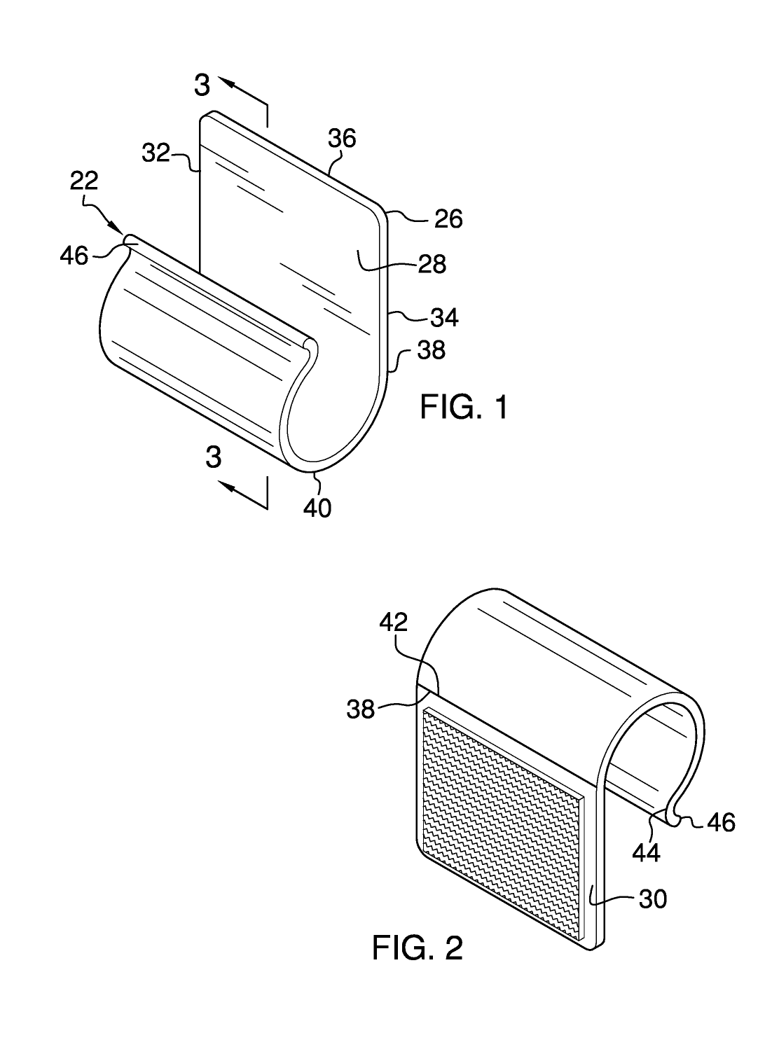

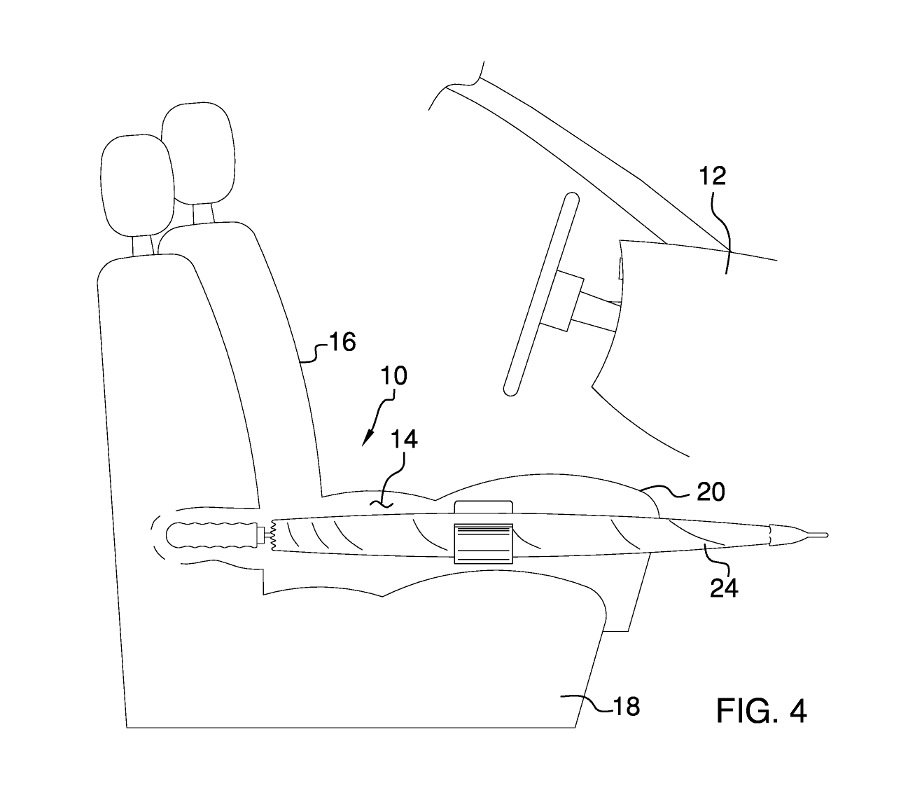

With reference now to the drawings, and in particular to FIGS. 1 through 4 thereof, a new umbrella holding device embodying the principles and concepts of an embodiment of the disclosure and generally designated by the reference numeral 10 will be described.

As best illustrated in FIGS. 1 through 4, the umbrella mounting system 10 generally comprises a vehicle 12 including an interior surface 14. The vehicle 12 would generally include typical passenger vehicle with a driver's seat 16, a passenger seat 18 and a console 20 positioned between the two. While any interior space might be utilized, the system 10 may be most suited for utilizing a side wall of the console 20 as the interior surface 14 and more particularly the surface facing the passenger seat 18.

A clip 22 is attached to the interior surface 14 and is configured for engaging an umbrella 24. The clip 22 includes a mount section 26 that is attached to the interior surface 14. The mount section 26 is planar and has a front side 28, a back side 30, an upper edge 36, a lower edge 38 and a pair of lateral edges 32, 34. The mount section 26 may have a height from the upper edge 36 to the lower edge 38 between 2.0 inches and 4.0 inches and may have a width between the lateral edges 32, 34 between 3.0 inches and 6.0 inches. A saddle 40 is attached to the lower edge 38 and is formed in a semi-cylindrical shape that has a first end 42 and a second end 44. The first end 42 is attached to and extends along the lower edge 34. The saddle 40 has a diameter between 2.0 inches and 3.0 inches. The saddle 40 forms between 60% and 80% of a cylinder such that that the second end 44 extends over a portion of the saddle 40 when the mount section 26 is vertically oriented and extends toward the mount section 26. The second end 44 of the saddle 40 is spaced form the front side 28 a distance less than the diameter. A lip 46 is attached to the second end of the saddle 40 and extends away from the mount section 26. The clip 22 may be comprised of a plastic material which is resiliently flexible to allow the saddle 40 to be opened for insertion and removal of the umbrella 24 and is biased against the umbrella 24 due to the material characteristics of the clip 22.

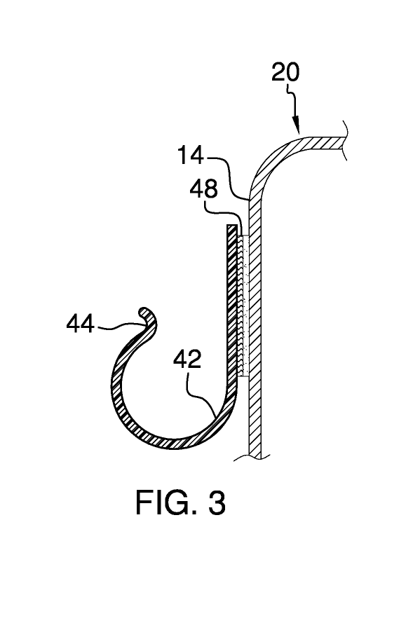

A securing member 48 attaching the clip 22 to the interior surface. The securing member 48 may include a hook and loop coupler as shown in FIG. 3 to allow the clip 22 to be removed from the interior surface 14. However, a permanent adhesive or mechanical fasteners such as screws may be used to secure the mount section 26 to the interior surface 14.

In use, the clip 22 is mounted in the vehicle 12 as stated above and shown in the Figures. Once the clip 22 is positioned, the umbrella 24 is removably positioned in the clip 22. The positioning of the clip 22 will ensure that the umbrella 24 is easily accessible and prevents the umbrella 24 from being laid upon a seat or floor surface preventing its proper drying after usage.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An umbrella holding system comprising:
a vehicle including an interior surface;
a clip being attached to said interior surface, said clip including:
a mount section being attached to said interior surface, wherein said mount section is planar and has a front side, a back side, an upper edge, a lower edge and a pair of lateral edges;
a saddle being attached to said mount section, said saddle being attached to said lower edge, wherein said saddle is formed in a semi-cylindrical shape and having a first end and a second end, said first end being attached to and extending along said lower edge;
a lip being attached to said second end of said saddle and extending away from said mount section, said lip being curved outwardly away from said mount section;
a securing member attaching said clip to said interior surface; and
an umbrella being removably positioned in said clip.

2. (canceled)

3. The umbrella holding system according to claim 2, wherein said mount section has a height from said upper edge to said lower edge between 2.0 inches and 4.0 inches, said mount section having a width between said lateral edges between 3.0 inches and 6.0 inches.

4. (canceled)

5. The umbrella holding system according to claim 4, wherein said saddle has a diameter between 2.0 inches and 3.0 inches, said second end of said saddle being spaced form said front side a distance less than said diameter.

6. (canceled)

7. An umbrella holding system comprising:
a vehicle including an interior surface;
a clip being attached to said interior surface, said clip including:
a mount section being attached to said interior surface, said mount section being planar and having a front side, a back side, an upper edge, a lower edge and a pair of lateral edges, said mount section having a height from said upper edge to said lower edge between 2.0 inches and 4.0 inches, said mount section having a width between said lateral edges between 3.0 inches and 6.0 inches;
a saddle being attached to said lower edge, said saddle being formed in a semi-cylindrical shape and having a first end and a second end, said first end being attached to and extending along said lower edge, said saddle having a diameter between 2.0 inches and 3.0 inches, said second end of said saddle being spaced form said front side a distance less than said diameter;
a lip being attached to said second end of said saddle and extending away from said mount section, said lip being curved outwardly away from said mount section;
a securing member attaching said clip to said interior surface; and
an umbrella being removably positioned in said clip.
